(19) United States
(12) Patent Application Publication
(10) Pub. No.: US 2008/0121647 A1
(43) Pub. Date: May 29, 2008

(54) Dispensing Machine

(75) Inventor: Stephen W. Erwin, Queensland (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Vend-Tech Solutions Holding PTY Ltd, Kirrawee (AU)

(21) Appl. No.: 11/660,459

(22) PCT Filed: Aug. 19, 2005
(86) PCT No.: PCT/AU05/01248

§ 371 Date: Sep. 25, 2007

(30) Foreign Application Priority Data
Aug. 19, 2004 (AU) 2004904718

(51) Int. Cl. G07F 9/00; G07F 11/02

(52) U.S. Cl. 221/7; 221/97

(57) ABSTRACT

A modular dispensing machine for dispensing at least one product including at least one control unit for controlling the dispensing of the at least one product and at least one dispensing unit, the at least one control unit and the at least one dispenser unit each housed in its own housing which are removably attachable relative to one another such that one or more dispensing units can be removably attached to a single control unit to control the at least one dispensing unit.

### FIELD OF THE INVENTION

The present invention relates to dispensing machines and in particular to vending machines for dispensing goods in response to a customer tendering payment for the goods.

### BACKGROUND ART

At the moment, the majority of Australian retailers provide non-biodegradable plastic carry bags which end up as landfill or litter. Some of these bags are recycled at supermarket collection bins, but this is only a very small percentage of the total number of bags used.

Each year Australians throw away six billion plastic bags. That's 12,000 bags a minute, most discarded after one use.

The plastic bags clog waterways and kill thousands of sea birds, sea mammals and fish each year. Turtles, dolphins and killer whales mistake them for jellyfish and die of intestinal blockage.

Bags contaminate kerbside recycling, can remain undegraded in the environment for up to 1000 years, and cause problems for landfill.

There has been debate on the use of plastic bags but little action. The major supermarket chains have adopted the policy of asking customers if they need a bag. They have designed calico bags, and tried box systems.

The momentum for change is building. Ireland's [symbol] 15 cent (26 cents) plastic bag tax, introduced in March 2002, has cut the number of discarded bags by 95 percent.

Federal Ministers in some countries have warned that if consumers do not cut down on plastic bags they will consider imposing a tax or levy on them.

Recent surveys have shown that about 70 percent of consumers worry that plastic bags harm the environment.

There are alternatives. One is the biodegradable plastic bag, which has cobalt in it. The cobalt breaks down the plastic within one and three years. Another is corn starch bags that biodegrade in four to six weeks.

There are various systems available for dispensing goods purchased from vending machines.

One such system is provided for vending products such as beverage and other food products, preferably individually packaged, from a storage unit to a customer terminal at a remote location through a pneumatic tube conveyor to move the product from storage to a dispensing unit at the remote location in response to product selection made by a customer at the remote location. For example, the system may sell food, beverages or vehicle care products to customers at a fuel dispensing station by charging to a fuel charge system having a credit card reader associated with a self-service fuel pump to process the fuel purchase charge. The product is preferably moved through the conveyor in a reusable carrier or in its own product packaging container that serves as a carrier.

Another system uses an existing product vending machine as a storage and loading device for use in a pneumatic vending and delivery system along with an interface unit in place of the vending machine door. A product dispensing terminal is connected by the delivery tube of a pneumatic conveyor from the storage and loading device, which has a loading mechanism configured to load a product dispensed by the dispensing mechanism into the delivery tube. The pneumatic conveyor includes a back pressure source operable to apply reverse pressure to a product in the delivery tube to gently slow a product approaching the product dispensing terminal through the tube. A gate is selectively moveable into and out of the path of a product proximate the outlet end of the delivery tube to stop a product slowed by the back pressure source and to release the stopped product for delivery to a customer at the product dispensing terminal. The loading mechanism includes a moveable member connected at one end to a blower and having an open end configured to receive a product dispensed by the dispensing mechanism and to seal the inlet end of the delivery tube with the received product positioned between the blower and the tube. The moveable member is preferably a bucket shaped element pivotally mounted to move between an open position for receiving a product dispensed by the dispensing mechanism and a closed position sealing the inlet to the deliver tube.

Bag and sack storage dispensers are also known. These generally have a housing that is secured to a mounting surface, preferably on the interior of a kitchen cabinet door. The housing has an integral frame that supports sacks or bags or other planar items during storage. The frame depends from a vertical base that mounts directly to the mounting surface. A horizontal support panel extends outwardly from the door and base. An auxiliary support panel may also extend outwardly from the door and the base. The auxiliary panel extends parallel to but beneath the primary support panel. Each panel has at least one elongated slot penetrating its surface, although there may be more. The slots preferably run parallel to one another and perpendicularly intersect the base. An elongated leg protrudes outwardly from each slot toward the base. Each leg has a foot on one end that secures the leg to the panel. The foot comprises a follower that moves in the slot. The other leg end comprises a terminal, resilient end that is oriented toward the cabinet door or other base attachment surface. A biasing assembly ensures that each leg is normally biased toward the cabinet door or other base attachment surface.

Simpler dispensers are known. One such dispenser is a dispenser having a top surface and a front surface with a cut-out extending between the front and top surfaces with slits extending from sides of said cut-out along the front surface. A stack of plastic bags or plastic sheet pick-up tissues are arranged in the dispenser and are dispensed by grasping an uppermost one via the cut-out and pulling outward with the bags being pulled one at a time through the cut-out and slits.

There are also automatic bag systems for supermarket check-out counters. These machines generally have some form of heat sealer for operation in relation to plastic rolls which form a bag around items positioned within the machine.

All of the above dispensers generally dispense disposable plastic bags. As described above, these bags cause or contribute to an environmental problem. None of the above dispensers are adapted to dispense bags which may be reusable.

### SUMMARY OF THE INVENTION

The present invention is directed to a dispensing machine, which may at least partially overcome the abovementioned disadvantages or provide the consumer with a useful or commercial choice.

In a broad form, the invention resides in a modular dispensing machine for dispensing at least one product including at least one control unit for controlling the dispensing of the at least one product and at least one dispensing unit, the at least one control unit and the at least one dispenser unit each housed in its own housing which are removably attachable relative to one another such that one or more dispensing units can be removably attached to a single control unit to control the at least one dispensing unit.

It is particularly preferred that the dispensing machine according to the present invention dispenses paper bags. The invention according to the broadest form however, may be used to dispense other types of bags such as woven high density polyethylene bags for example. Other types of bags may be dispensed in the alternative or in addition to the types described above such as bags made from calico or other types of cloth, or bags containing biodegradable material.

Preferably, the respective control and dispensing housings of the machine include a front and rear wall. The control housing will typically include a front and a rear wall with a side wall linking the front and rear wall, as well as a top and base wall. The control housing will preferably not be provided with a second side wall, but instead, be attached to the dispensing housing along that open side.

The dispensing housing will typically include a front wall in the form of a door and a rear wall as well as a top and base wall. The control housing will preferably be provided with an opening along one side to be attached to the control housing along that open side. On the opposing side of the housing, a removable side wall may be provided. Where a first dispensing housing is provided between a control unit and a second dispensing housing (or between a pair of dispensing housings), the first dispensing housing may be provided with a pair of openings, one on either side of the housing, one to attach the control housing (or dispensing housing) and the other to attach to the dispensing housing.

Each of the at least one dispensing units includes a housing preferably having an interior and an exterior, at least one storage compartment for storing the product located in the interior of the housing, a dispensing compartment accessible from the exterior of the housing, product moving means positioned to allow movement between the at least one storage compartment and the dispensing compartment, the product moving means adapted to engage the product stored in the storage compartment, and hold the product during a movement cycle, and control means to control the movement of the product moving means.

The product moving means may suitably be a scoop means. Each dispenser unit may include a product moving means. The scoop means may be specifically adapted to engage bags which are folded at least partially when in the storage compartment. Paper bags generally have a base, a front and opposed back wall and two side walls, with an opening at the top. Typically, when paper bags are folded flat for transport, the base of the bag is folded to be flat against either the front wall or the back wall of the bag. The side walls are folded approximately in half inwardly and at a lower portion of the bag, the side walls and the front or back wall are further folded to allow the base to abut the front or back wall.

The scoop means may preferably engage the bag at the fold of the front or back wall between the front or back wall and the abutting base wall.

The scoop means may include a scoop member. The scoop member may be an L-shaped member, with the respective portions thereof being termed an upright portion and a base portion, regardless of configuration. Each portion may have a free end and an attached end.

The scoop means may be mounted to be rotatable about the free end of the upright member. The scoop means is generally pivotally mounted about a rod or similar. The free end of the base portion may engage the product. Different products may be engaged in different manners dependant upon their configurations. Where the machine of the present invention dispenses bags, the free end of the base portion, and suitably the leading edge of the base portion may engage the fold of the bags as discussed above. Where other products are dispensed, the base portion may engage them in ways suitable to the product.

The scoop means is generally associated with a drive means to rotate the scoop means. The scoop means is generally pivotally mounted on a rod, and the drive means is suitably associated with the rod. One or more armatures may attach the rod to the drive means as the drive means is typically a motor or similar and will be located spaced from the rod and scoop means. The scoop means may generally rotate about a substantially horizontal axis. The scoop means may be adapted to rotate about 360° or through an arc only. An arc movement is preferred as it is generally easier to control than a total rotation.

The scoop member will typically move from a rest position in which the L-shaped member is substantially upright, into a loaded position in which a product is loaded onto the scoop and the base portion of the scoop member is rotated upward until the bag engages a bag clamp. The bag clamp engages and holds the bag and the scoop member returns to the rest condition. This movement is suitably a cycle. One cycle will preferably always terminate with the scoop member in the rest position with a bag loaded in the bag clamp. When a customer inserts money to purchase a product, the bag clamp releases the bag held in the clamp and the cycle begins.

The dispenser unit may also include a diverter means. Usually, the diverter means will be a diverter flap, having a raised and a lowered condition and being biased into the lowered condition.

The diverter flap may be a substantially planar member which is suitably pivotally mounted toward the front of each dispenser housing. Suitably, the scoop member rotates in a first direction and the diverter flap in the opposite direction. Suitably the diverter flap is mounted for rotation about a horizontal axis. The diverter flap suitably operates to divert the product from the storage compartment to the dispenser compartment. As the scoop means rotates from the rest position towards the loaded position it may suitably lift the diverter flap into the raised condition allowing the scoop member and the product to pass and then falls back into the lowered condition preventing the product falling from the clamp back into the storage compartment. If the product falls from the clamp, the diverter flap directs the product into the dispensing compartment.

The diverter flap preferably has an opening therein which may be correspondingly sized and shaped to the scoop member. This may allow the scoop member to return to the rest position through the opening in the diverter flap. Suitably the base portion of the bag (where the bag is the product) may abut the diverter flap and lift it to the raised condition during the cycle.

As stated above, the dispenser unit may include a clamp means. The clamp means is preferably provided in an upper portion of the housing or access door of the dispenser units. The clamp means may preferably be provided at a terminus of the swing path of the scoop means. The clamp means may use any suitable configuration to receive and hold a product in the loaded position above the dispensing portion of the dispensing units.

In use, the machine may be located in a supermarket and users may approach the machine to inset money. This will activate the product moving means which will then move to dispense the number of bags that the user has paid for. The tendering of money or payment by the user may activate a dispensing cycle. The machine is particularly directed towards the dispensing of paper bags as they are more rigid than low density polyethylene plastic bags which are likely to be deformed and perhaps even destroyed by the product moving means.

Each housing may preferably be rectangular in configuration, having a front wall, two opposed sidewalls, a rear wall, a base and a top wall. The front wall may be at least partially see-through to allow a user to watch the workings of the machine. At least part of the front wall may suitably be see-through. Each of the housings, including that of the control unit my have at least one removable wall in order to allow the housings of collocated units to be attached to each other. For example, the control unit may be located at one end of a row of connected dispensing units and in this configuration, may have one fixed side wall and a removable side wall. The dispensing units may each have two removable side walls except for the end dispensing unit which will require only one removable side wall. In alternative configurations such as a control unit sandwiched between two dispensing units, the units may have appropriate numbers of removable side walls. Both side walls may be removable for all units to increase the flexibility of the attachment configurations but the side walls will typically only be removed when necessary to attach the units.

Each housing may typically be manufactured from a lightweight but strong material such as metal except obviously the see-through portions. These may be made of engineering plastics to maintain strength but remain see-through.

At least one of the walls may suitably have an access panel or door to allow access to the interior of the machine. This may be necessary for service of the machine or for loading of the bags. The door may suitably be hinged and may occupy the whole or only part of the wall. The door may be securable against theft and so may be lockable. There may be more than one door. Generally, for example, there may be a door or access panel to allow a user to access the dispensing compartment. This door is not necessarily positioned on the rear or side walls and most preferably is on the front wall of the housing. This door is preferably only openable during the dispensing cycle and is secured at all other times.

Each housing may include one or more reinforced portion to reduce damage suffered by the housing and also to increase the security of the machine. As an example, the corners of the housing may be reinforced to prevent damage to them, or the housing may be reinforced around any access panels to facilitate locking the housing.

Each housing may suitably be on wheels or castors to allow the machine to be moved more easily. The wheels may be securable to prevent the machine moving when movement is not desired. Securable wheels of this kind are well known and any type may be used.

Each housing may also be equipped with lifting lugs to allow movement by cranes or forklifts, for example. It is envisaged that the machine may be rather heavy and lifting lugs may be desired.

Each dispenser unit housing may contain at least one and possibly multiple storage compartments. Each storage compartment may suitably be rectangular or bin-like in shape with an open top into which the scoop means may extend. There may be an opening in at least one of the side walls of the or each storage compartment to allow a lifting means to lift the products so that at least one of the products is always within reach of the moving means. There may be more than one storage compartment in each dispensing unit and in this case the storage compartments may contain different size bags.

Each storage compartment may suitably be shaped to suit the shape of the bags to be stored and dispensed. It is envisaged that a number of different shape bags may be used in conjunction with the machine. The different sized and shaped bags may be provided in one or more additional dispensing units associated with the same control unit or more than on size and shape of bags can be provided in the same dispensing unit.

Part of one or more storage compartments may suitably be seen through so that an indication of the inventory of bags disposed therein may be taken from outside the machine. The remainder of the storage compartment may generally be manufactured from a strong material such as metal or plastics.

The storage compartments may suitably not engage the bags closely. The walls of the compartments may be spaced a small distance from the periphery of the bags. The spacing may suitably not be so great that the bags are moved out of alignment while being moved. There may be a holding means to hold the upper bags in a bag stack in position against accidental movement.

In a particularly preferred embodiment, each storage compartment may include a base, a front and an opposed rear wall and two opposed side walls. The base may have a movable base or a movable plate positioned above the base which can move up and down. Suitably the movable plate may be an indexing plate, movable in small controlled increments. The bags may suitably be placed on this moveable plate during loading of the storage compartment. This moveable plate may move upward as the bags are used through provision of a spring or other type of resilient means or alternatively through the means or a threaded rod that rotates a pre-set amount to move the plate up or down. The movement of the plate may be controlled. The plate may be moved upward in small increments as bags are dispensed to allow a bag to always be in position for engagement with the scoop means until the storage compartment is empty.

The moveable plate may move the bags upwards towards the scoop means.

In another embodiment, the base may be fixed in position and the scoop means may be movable within the storage compartments to the bags. In this embodiment, the scoop means may have an extendible arm member to allow the movement within the storage compartment.

The movable plate in the storage compartment may suitably be moved utilizing compressed air or pneumatically, or using a mechanical system. Other methods of movement are envisaged such as hydraulics. A pneumatic ram may suitably be used for the movement of the plate.

The storage compartment(s) may be removable from the housing. For example, multiple storage compartments may be provided on a single movable platform or the like. The storage compartments may be filled prior to the platform being installed in the dispensing unit where it may remain until most or all of the bags have been dispensed. A replacement platform with loaded storage compartments may then replace the partially empty platform. This may allow the storage bin to be loaded with bags more easily and thereby facilitate refilling. The storage platform may be on wheels which may be securable to prevent any undesirable movement of the storage compartment.

The bags with which the storage compartment is loaded are preferably be disposed in a horizontal, flattened position with the base portion of the bags abutting the front or back wall of the bags, as described above, being uppermost. This position may allow the scoop means to engage and hold the bags more easily.

The dispensing compartment may suitably be positioned adjacent to the storage compartment within the housing. It may be positioned such that the bags disposed within the storage compartment cannot be reached through any access door in the housing. This may prevent theft of the bags.

The access door to the dispensing compartment may only be opened as a part of the dispensing cycle. At all other times the access door may be secured with the last step in the dispensing cycle being the securing of the access door in the closed position. Preferably, the dispensing cycle may not start while the access door is opened. There may suitably be a “cutout” switch to prevent operation of the machine while the door is opened.

The dispensing compartment may be shaped to allow the bags positioned therein to be readily accessible to a user upon opening the access door. In a particularly preferred embodiment, the dispensing compartment may triangular prism shaped, having two opposed sidewalls, each shaped as a right-angled triangle. The sidewalls may be joined by a rectangular wall joining the hypotenuse of each triangular sidewall. An access opening may be positioned in lieu of the remaining wall. This access opening may be sealed by the access door to the dispensing compartment.

The rectangular wall joining the hypotenuse of each triangular sidewall may be disposed towards the base of the housing to allow any bags within the dispensing compartment to be directed downwardly and forwardly.

The scoop means may suitably be associated with a track or some other type of guide means to allow easy movement between the rest and the loaded positions. The track or guide means may be equipped with stops at the extremities of movement to prevent movement outside these bounds. Aspects of the position and movement of the scoop means may suitably be controlled.

The control unit may suitably include a means for accepting payment for the bags as well as a control means for controlling the one or more dispensing units. The control means may be separate from the means for accepting payment but in use the two may be connected to allow the control means to start the dispensing cycle once the payment has been made through the means for accepting.

The means for accepting payment may be capable of accepting payment in any form including credit card, Electronic Funds Transfer (EFT), coins, notes or any combination of these. The means for accepting payment may suitably be capable of recognizing the denomination of payment and giving change if required.

The control means may allow the user of the machine to select the size of the bag required if the machine has more than one size bag contained therein. Combinations of bags may also be chosen. Where multiple dispensing units are associated with each control unit, the user may be able to chose the size of bags dispensed even if the bags are in different dispensing units. Where all the dispensing units house the same size of bag, the dispensing units may empty in a predetermined pattern or order.

The control means preferably controls all of the moving parts of the machine including the product moving means, the moveable plate in the storage compartments (if applicable), the means for accepting payment and giving change, opening of the access door to the dispensing compartment and the power source for the machine including the source of the power used in the drives of the machine.

The control means may also control the movement and position of the dispensing means preferably through a feedback control loop.

The control means may suitably control the machine so that the tasks required to dispense a bag are performed in the desired format or order to accomplish the dispensing of the bag. The control means may suitably be a Programmable Logic Controller (PLC).

The control means may preferably include a MODEM in communication with a digital counting means. This feature may suitably allow monitoring of the level of inventory in the form of bags in each dispensing machine from a remote location. The remote location may be a central location adapted to monitor the number of bags in a number of machines spread over an area.

Each dispensing machine may preferably be equipped with an inventory level indicator.

The dispensing machine is preferably coin operated and includes control means which activates the cycle and any other internal workings of the dispensing machine in response to indication of receipt of the correct amount of money.

The bags which may be used in the machine may be of any type suitable for flat packing. The bags may be of any size or type of paper, for example small, medium or large bags, bags with integral handles, and wax-lined bags for damp and/or cold foodstuffs.

The step of accepting payment may occur at any stage in the process and the payment may even be performed remotely.

As stated above, there may be more than one type of bag available from a single machine. Suitably, a single dispensing machine may dispense a selection of bags of differing dimensions as well as a selection of bags manufactured from different materials.

The dispensing machine of the present invention may further preferably comprise an information screen located on the front or upper portion of the machine. The information screen may suitably be in the form of a playback device capable of playing prerecorded messages such as information messages about the damage caused by disposable plastic bags. Ideally, the information screen may be interactive. The information screen may suitable be capable of displaying television signals or other signals. The information screen may be provided on the control unit or any one or more of the dispensing units.

### BRIEF DESCRIPTION OF THE DRAWINGS

An embodiment of the invention will be described with reference to the following drawings, in which:

FIG. 1 is a perspective view of the dispensing machine showing the modular nature of the machine.

FIG. 2 is a partial detail perspective view of a dispensing unit according to a preferred embodiment of the present invention showing the internal workings of the unit.

### DETAILED DESCRIPTION OF THE INVENTION

According to an aspect of the invention, a dispensing machine 10 for dispensing at least one product is provided.

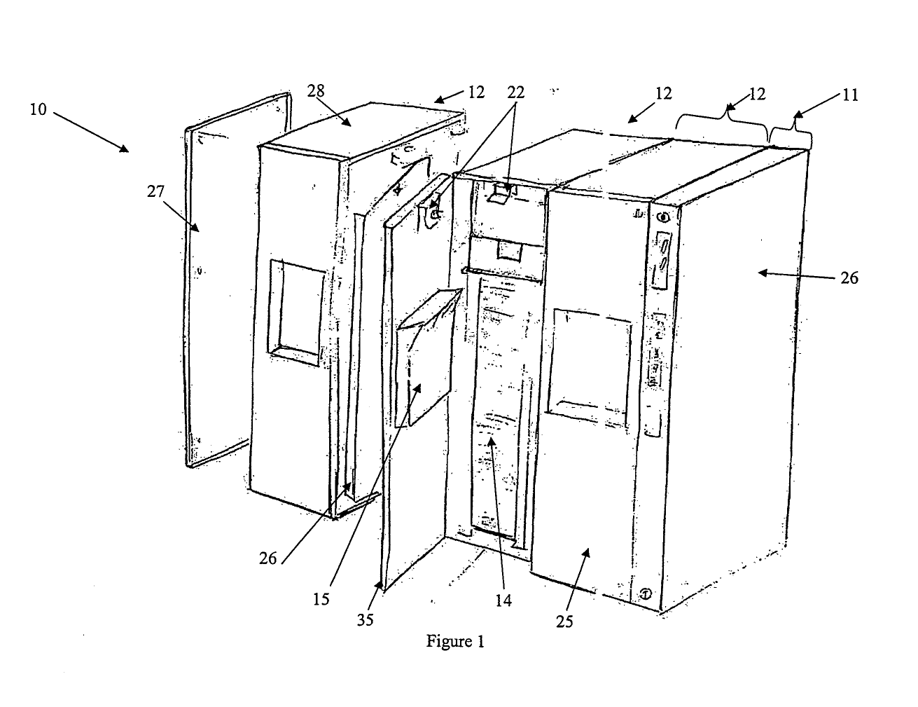

The dispensing machine is modular in nature, and as illustrated in FIG. 1, includes one control unit for controlling the dispensing of the product (not shown) and a plurality of dispensing units 12. The control unit 11 and the dispenser units 12 are each housed in its own housing 13 which are removably attachable relative to one another such that dispensing units 12 can be removably attached to a single control unit 11 to control the operation of the dispensing units 12.

It is particularly preferred that the dispensing machine 10 according to the present invention dispenses paper bags. The invention according to the broadest form however, may be used to dispense other types of products including bags such as woven high density polyethylene bags for example. Other types of bags may be dispensed in the alternative or in addition to the types described above such as bags made from calico or other types of cloth, or bags containing biodegradable material.

Each of the dispensing units 12 includes a housing 13 having an interior and an exterior. Each housing has a storage compartment 14 for storing the product located in the interior of the housing 13, a dispensing compartment 15 accessible from the exterior of the housing 13, product moving means positioned to allow movement between the storage compartment 14 and the dispensing compartment 15, the product moving means adapted to engage the product stored in the storage compartment 14, and hold the product during a movement cycle, and a control means to control the movement of the product moving means.

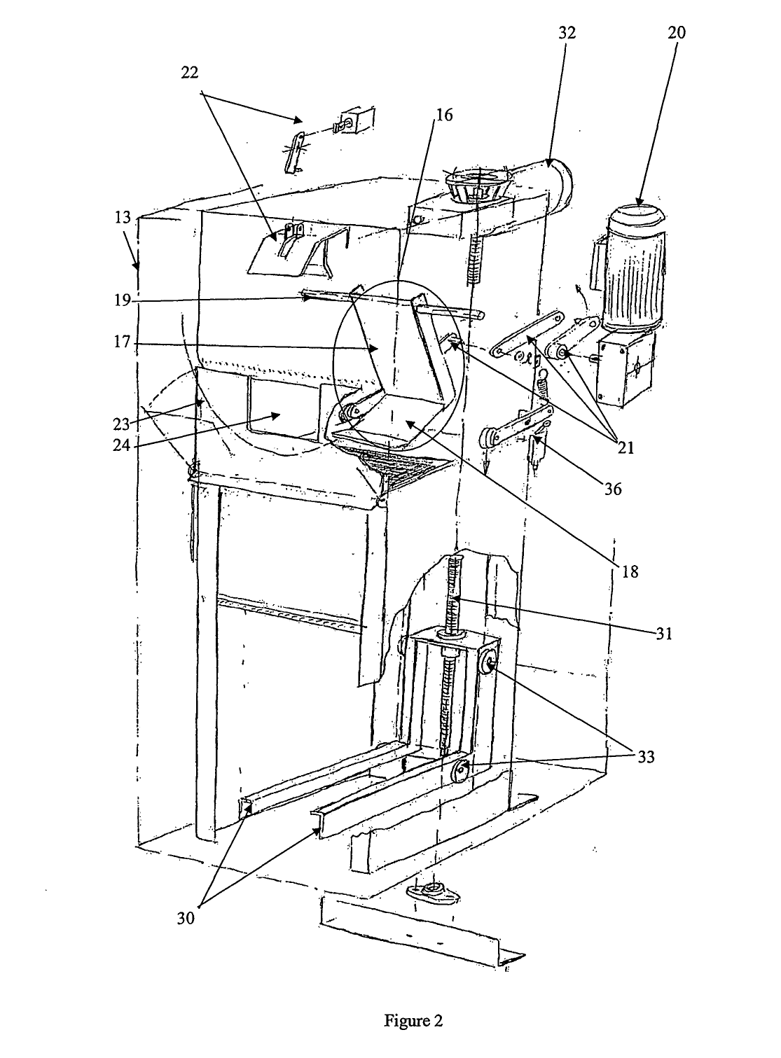

The product moving means as illustrated in FIG. 2 is a scoop member 16. The scoop member 16 is specifically adapted to engage bags which are folded at least partially when in the storage compartment 14. Paper bags generally have a base, a front and opposed back wall and two side walls, with an opening at the top. Typically, when paper bags are folded flat for transport, the base of the bag is folded to be flat against either the front wall or the back wall of the bag. The side walls are folded approximately in half inwardly and at a lower portion of the bag, the side walls and the front or back wall are further folded to allow the base to be folded to abut the front or back wall.

The scoop member 16 engages the bag at the fold of the front or back wall between the front or back wall and the abutting base wall. The scoop member 16 is an L-shaped member, with the respective portions thereof being termed an upright portion 17 and a base portion 18, regardless of configuration. Each portion has a free end and an attached end.

The scoop member 16 is mounted to be rotatable about the free end of the upright portion 17. The scoop member is pivotally mounted about a rod 19 and the free end of the base portion 18 engages the fold of the bag. Different products may be engaged in different manners dependant upon their configurations.

The scoop member 16 is associated with a scoop drive means 20 to rotate the scoop member 16. The scoop member 16 is pivotally mounted on the rod 19, and the scoop drive means 20 is associated with the rod 19. One or more armatures 21 are used to attach the rod 19 to the scoop drive means 20 as the drive means is typically a motor or similar and will be located spaced from the scoop means 16. The scoop member 16 illustrated rotates about a substantially horizontal axis. The scoop member 16 may rotate about 360°, however an arc movement is preferred as it is generally easier to control than a total rotation.

The scoop member 16 will typically move from a rest position in which the L-shaped member is substantially upright, into a loaded position in which a bag is loaded onto the scoop member 16 and the base portion 18 of the scoop member 16 is rotated upward until the bag engages a bag clamp 22. The bag clamp 22 engages and holds the bag and the scoop member 16 returns to the rest condition. This movement is a cycle. One cycle will preferably terminate with the scoop member 16 in the rest position with a bag loaded in the bag clamp 22. When a customer inserts money to purchase a product, the bag clamp 22 releases the bag held in the clamp 22 and the cycle begins.

The dispenser unit 12 may also include a diverter flap 23, having a raised and a lowered condition and being biased into the lowered condition.

The diverter flap 23 is a substantially planar member which is pivotally mounted toward the front of each dispenser unit 12 housing. The scoop member 16 rotates in a first direction and the diverter flap 23 in the opposite direction. The diverter flap 23 is mounted for rotation about a horizontal axis. The diverter flap 23 operates to divert the bag from the storage compartment 14 to the dispenser compartment 15. As the scoop member 16 rotates from the rest position towards the loaded position, it may suitably lift the diverter flap 23 into the raised condition allowing the scoop member 16 and the bag to pass, and then falls back into the lowered condition, preventing the bag falling from the clamp 22 back into the storage compartment 14. When the bag falls from the clamp 22, the diverter flap 23 directs the bag into the dispensing compartment 15.

The diverter flap 23 has an opening 24 therein, correspondingly sized and shaped to the scoop member 16. This allows the scoop member 16 to return to the rest position through the opening 24 in the diverter flap 23. Suitably, the base portion of the bag (where the bag is the product) may abut the diverter flap 23 and lift it to the raised condition during the cycle.

As stated above, each dispenser unit 12 may include a clamp means 22. The clamp means 22 is provided in an upper portion of the housing 13 of the dispenser units 12. The clamp means 22 is provided at a terminus of the swing path of the scoop member 16. The clamp means 22 may use any suitable configuration to receive and hold a product in the loaded position above the dispensing compartment 15 of the dispensing units 12.

In use, the dispensing machine 10 may be located in a supermarket and users may approach the machine to inset money. This will activate the product moving means which will then move to dispense the number of bags that the user has paid for. The tendering of money or payment by the user may activate a dispensing cycle. The machine is particularly directed towards the dispensing of paper bags as they are more rigid than low density polyethylene plastic bags which are likely to be deformed and perhaps even destroyed by the product moving means.

Each housing 13 will generally be rectangular in configuration, having a front wall 25, two opposed sidewalls 26, 27, a rear wall (not shown), a base (not shown) and a top wall 28. Each of the housings 13, including that of the control unit may have at least one removable wall in order to allow the housings 13 of collocated units to be attached to each other. For example, the control unit 11 may be located at one end of a row of connected dispensing units as seen in FIG. 1, and in this configuration, has one fixed side wall and a removable side wall. The dispensing units 12 each have two removable side walls except for the end dispensing unit 12 which has only one removable side wall, the second illustrated separately for illustration purposes only.

Each housing will be manufactured from a lightweight but strong material such as metal.

At least one of the walls of the housing has an access panel or door 35 to allow access to the interior of the machine. This may be necessary for service of the machine or for loading of the bags. The door 35 is hinged and may occupy the whole or only part of the wall. The door 35 is securable against theft and so may be lockable. There may be more than one door. Generally, there may be a further door or access panel to allow a user to access the dispensing compartment. This door is not necessarily positioned on the rear or side walls and most preferably is on the front wall of the housing. This door is preferably only openable during the dispensing cycle and is secured at all other times.

Each storage compartment 14 is shaped to suit the shape of the bags to be stored and dispensed. It is envisaged that a number of different shape bags may be used in conjunction with the machine. The different sized and shaped bags may be provided in one or more additional dispensing units 12 associated with the same control unit 11 or more than one size and shape of bags can be provided in the same dispensing unit 12.

The storage compartments 14 may suitably not engage the bags closely. The walls of the compartments will be spaced a small distance from the periphery of the bags. The spacing may suitably not be so great that the bags are moved out of alignment while being moved but enough so as not to inhibit the movement of the bags. There is a holding means 36 to hold the upper bags in a bag stack in position against accidental movement.

In a particularly preferred embodiment, each storage compartment includes a base, a front and an opposed rear wall and two opposed side walls. The base includes a movable base 30 which can move up and down. Suitably the movable base 30 is an indexing base, movable upwards in small controlled increments. The bags are placed on the moveable base 30 during loading of the storage compartment 14. The moveable base 30 moves upward as the bags are used, through provision of a threaded rod 31 that rotates a pre-set amount to move the base 30 up or down. The movement of the base 30 will be controlled and the base 30 will be moved upward in small increments as bags are dispensed to allow a bag to always be in position for engagement with the scoop member 16 until the storage compartment 14 is empty.

The movable base 30 is moved utilizing a mechanical system of the threaded rod 31 and a drive 32 to rotate the rod 31.

The bags with which the storage compartment 14 is loaded are disposed in a horizontal, flattened position with the base portion of the bags abutting the front or back wall of the bags, as described above, being uppermost. This position may allow the scoop member 16 to engage and hold the bags more easily.

The dispensing compartment 15 is positioned adjacent to the storage compartment 14 within the housing. It is positioned such that the bags disposed within the storage compartment 14 cannot be reached through any access door in the housing to prevent theft of the bags.

The access door to the dispensing compartment 14 may only be opened as a part of the dispensing cycle. At all other times the access door will be secured with the last step in the dispensing cycle being the securing of the access door in the closed position. Preferably, the dispensing cycle may not start while the access door is opened. There may suitably be a “cutout” switch to prevent operation of the machine while the door is opened.

The dispensing compartment 15 is shaped to allow the bags positioned therein to be readily accessible to a user upon opening the access door.

The scoop means and the threaded rod 31 and movable base 30 will associated with guide wheels 33 or some other type of guide means to allow easy movement between positions. The guide wheels 33 may be equipped with stops at the extremities of movement to prevent movement outside these bounds. Aspects of the position and movement of the scoop means may suitably be controlled.

The control unit 11 will include a means for accepting payment for the bags as well as a control means for controlling the one or more dispensing units. The control means may be separate from the means for accepting payment but in use the two may be connected to allow the control means to start the dispensing cycle once the payment has been made through the means for accepting.

The means for accepting payment will be capable of accepting payment in any form including credit card, Electronic Funds Transfer (EFT), coins, notes or any combination of these. The means for accepting payment will suitably be capable of recognizing the denomination of payment and giving change if required.

Each dispensing machine will be equipped with an inventory level indicator.

The dispensing machine illustrated is coin operated and includes control means which activates the cycle and any other internal workings of the dispensing machine in response to indication of receipt of the correct amount of money.

The bags which may be used in the machine may be of any type suitable for flat packing. The bags may be of any size or type of paper, for example small, medium or large bags, bags with integral handles, and wax-lined bags for damp and/or cold foodstuffs.

In the present specification and claims, the word “comprising” and its derivatives including “comprises” and “comprise” include each of the stated integers but does not exclude the inclusion of one or more further integers.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A modular dispensing machine for dispensing at least one product including at least one control unit for controlling the dispensing of the at least one product and at least one dispensing unit, the at least one control unit and the at least one dispenser unit each housed in its own housing which are removably attachable relative to one another such that one or more dispensing units can be removably attached to a single control unit to control the at least one dispensing unit.

2. A modular dispensing machine according to claim 1 wherein the machine dispenses reuseable or biodegradeable bags.

3. A modular dispensing machine according to claim 1 wherein each of the at least one dispensing units includes a housing preferably having an interior and an exterior, at least one storage compartment for storing the product located in the interior of the housing, a dispensing compartment accessible from the exterior of the housing, product moving means positioned to allow movement between the at least one storage compartment and the dispensing compartment, the product moving means adapted to engage the product stored in the storage compartment, and hold the product during a movement cycle, and control means to control the movement of the product moving means.

4. A modular dispensing machine according to claim 1 wherein the at least one dispensing unit includes product moving means specifically adapted to engage reuseable or biodegradeable bags which are stored in a folded condition.

5. A modular dispensing machine according to claim 4 wherein the product moving means is an L-shaped member, with an upright portion and a base portion, the base portion having a free end which engage a fold of the bags.

6. A modular dispensing machine according to claim 4 wherein the product moving means is associated with a drive means to rotate the product moving means through an arc only.

7. A modular dispensing machine according to claim 1 wherein the at least one dispensing unit is provided with at least one storage compartment having a movable base which moves upward as the products are dispensed.

8. A modular dispensing machine according to claim 2 wherein the bags are disposed in a horizontal, flattened condition.

9. A modular dispensing machine according to claim 1 wherein the control unit includes means for accepting payment in forms including credit or debit card, Electronic Funds Transfer (EFT), coins, notes and legal tender. The means for accepting payment may suitably be capable of recognizing the denomination of payment and giving change if required.

10. A modular dispensing machine according to claim 1 including a remote communications device in communication with a counting means to allow monitoring of the level of inventory in the dispensing machine from a remote location. The remote location may be a central location adapted to monitor the number of bags in a number of machines spread over an area.
